(19) United States
(12) Patent Application Publication
(10) Pub. No.: US 2023/0111044 A1
(43) Pub. Date: Apr. 13, 2023

(54) AUTOMATIC QUERY OPTIMIZATION FOR CONTROLLED DATA ACCESS

(71) Applicant: SAP SE, Walldorf (DE)

(72) Inventors: Dongqing Hu, Shanghai (CN); Ruiqi Kang, Shanghai (CN)

(21) Appl. No.: 17/499,983

(22) Filed: Oct. 13, 2021

(51) Int. Cl. G06F 16/2453; G06F 16/2455; G06F 16/2452; G06F 21/62

(52) U.S. Cl. CPC G06F 16/2453; G06F 16/24564; G06F 16/24528; G06F 21/6227

(57) ABSTRACT

Computer-readable media, methods, and systems are disclosed for applying rules and roles to generate optimized queries for optimized queries implementing restricted access to data. receiving, from a querying user, a data query including a data type and a query action. Roles associated with the querying user are retrieved from the querying user corresponding to the data type and the query action. A plurality of rules associated with the roles are retrieved by a security controller. Based on the rules and by way of the security controller, a query restrictor is computed to secure the data query for the action. One or more conditions associated with the rules are combined by conjunction. The rules associated with the role and the roles are combined by disjunction, to form restriction terms associated with the query restrictor. Finally, the data query is executed at a database server and results are returned.

### TECHNICAL FIELD

Embodiments generally relate to automatic query optimization for controlled data access. More specifically, embodiments relate to applying rules and roles to generate optimized queries for implementing restricted access to one or more databases.

Implementing secure queries to facilitate secure access to data may result in queries that take an excessive amount of time to complete. Software systems, and in particular, multi-tenant software systems typically have a requirement to provide configurable security policies, such that various user roles have varying levels of access to data within the software systems. The associated complex security access validations typically slow down query response times, resulting in resource-intensive computations. Such resource-intensive computations have a negative impact on user experience, for example when a query takes an excessive amount of time to complete. A current problem exists regarding how to satisfy both security and performance, especially in the context of querying large sets of data, which large sets of data can have an outsized impact on query response time and associated user experience for securing the data in a conventional manner. Accordingly, what is needed is a system for applying rules and roles to generate optimized queries for implementing restricted access to data, thereby addressing the above-mentioned problem.

### SUMMARY

Disclosed embodiments address the above-mentioned problems by providing one or more non-transitory computer-readable media storing computer-executable instructions that, when executed by a processor, perform a method for applying rules and roles to generate optimized queries for implementing restricted access to data, the method comprising: receiving, from a querying user, a data query including a data type and a query action, retrieving, by a security controller, roles associated with the querying user, the roles corresponding to the data type and the query action, loading, by the security controller, a plurality of rules associated with the roles, based on the rules and by way of the security controller, computing a query restrictor to secure the data query for the action, the computing comprising: combining by conjunction one or more conditions associated with the rules, combining by disjunction the rules associated with the role, and combining by disjunction the roles to form restriction terms associated with the query restrictor, and executing the data query at a database server.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1A is a system diagram illustrating providing a multi-tenant application platform having the capability to facilitate restricted access to data in connection with the current subject matter;

FIG. 1B is a process diagram illustrating a process for applying rules and roles to generate optimized queries for implementing restricted access to data in connection with the currently disclosed subject matter;

FIG. 2A is a hierarchical diagram illustrating relationships between a user, an action, a data type, and roles;

FIG. 2B is a hierarchical diagram illustrating relationships between roles and grants on the one hand and conditions on the other;

FIG. 3 is a hierarchical diagram illustrating an abstract condition tree;

FIG. 4 is a process flow diagram illustrating an exemplary process for applying rules and roles to generate optimized queries for implementing restricted access to data consistent with various embodiments; and

FIG. 5 is a diagram illustrating a sample computing device architecture for implementing various aspects described herein.

The drawing figures do not limit the invention to the specific embodiments disclosed and described herein. The drawings are not necessarily to scale, emphasis instead being placed upon clearly illustrating the principles of the disclosure.

### DETAILED DESCRIPTION

Disclosed herein are data security systems that support powerful and performant security configurations that are accomplished by way of automatic query optimization. In some embodiments, the automatic query optimizations are carried out at the application level instead of database level and are therefore capable of utilizing security-related values and relationships known at the application level, i.e., user roles and rules with associated conditions. A secure query against a large dataset may involve hundreds of conditions resulting in a huge query that cannot be executed by a database server in a sufficiently performant manner. The automatic optimizations disclosed herein can simplify the hundreds of conditions to a significantly smaller number of conditions, hence conserving computing resources and resulting in greatly improved query performance.

The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects of the disclosed invention in sufficient detail to enable those skilled in the art to practice the invention. Other embodiments can be utilized, and changes can be made without departing from the claimed scope of the invention. The following detailed description is, therefore, not to be taken in a limiting sense. The scope of embodiments is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

### Operational Environment for Embodiments

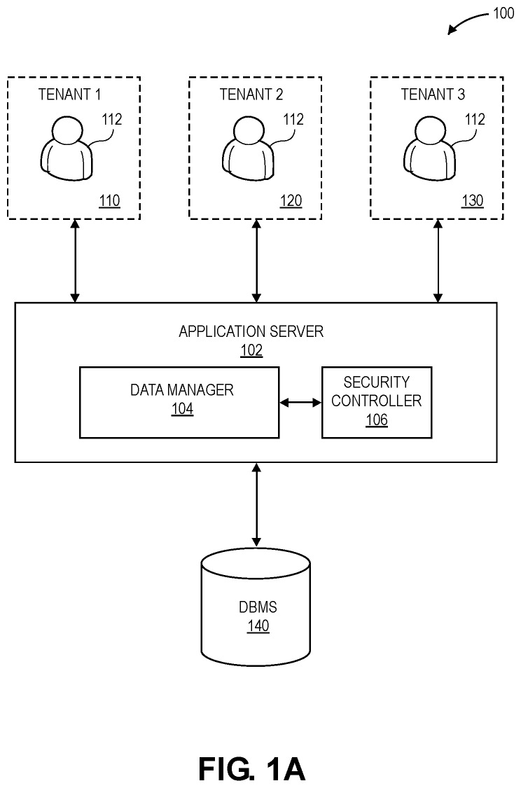

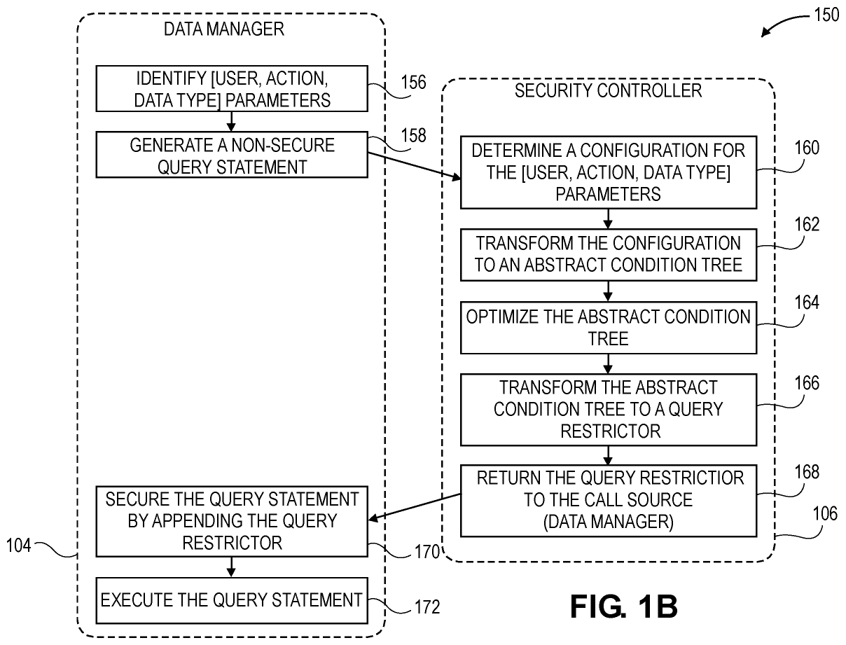

Turning first to FIG. 1A, which depicts a system diagram 100 for providing a multi-tenant application platform having the capability to facilitate restricted access to data in connection with the current subject matter. System 101 includes a plurality of tenants 110, 120, and 130, denominated “TENANT 1,” “TENANT 2,” and “TENANT 3” respectively. In some embodiments, each of the tenants generally have a requirement to access data within the multi-tenant application platform. Within the multiple tenants are a plurality of querying users 112. In some embodiments, a querying user 112 should have the capability to access data from database management system 140 (DBMS). In some embodiments, DBMS 140 includes metadata that can be accessed via a metadata manager. Metadata, in this context, can comprise a variety of objects, such as definitions of relational tables, columns, views, indexes and procedures. In some embodiments, metadata of all such types can be stored in one common database catalog for all stores. In these embodiments, the database catalog can be stored in tables in a row store forming part of a group of relational stores. Other aspects of DBMS 140 including, for example, support and multi-version concurrency control can also be used for metadata management. In some embodiments, DBMS 140 may also be a distributed database management system. In such embodiments, central metadata may be shared across multiple servers and the metadata manager can coordinate or otherwise manage such sharing.

In various embodiments, relational stores within DBMS 140 provide a foundation for different data management components. In these embodiments, relational stores can, for example, store data in main memory. In these embodiments, a row store, a column store, and a federation component are all relational data stores which can provide access to data organized in relational tables. The column store can store relational tables column-wise (i.e., in a column-oriented fashion, etc.). The column store may also include text search and analysis capabilities, support for spatial data, and operators and storage for graph-structured data.

In various embodiments, the row store stores relational tables row-wise. When a table is created, a creator specifies whether the table is to be row- or column-based. In various embodiments, tables can be migrated between the two storage formats of row- and column-based. While certain SQL extensions may be only available for one kind of table (such as the “merge” command for column tables), standard SQL may be used in connection with both types of tables. In various embodiments, the associated index server may provide functionality to combine both kinds of tables (column and row) in one statement (join, sub query, union).

In some embodiments, multi-tenant applications are provided, with each tenant being provided its own schema within DBMS 140. In these embodiments, each tenant 110, 120, 130 has its own data in separate tables partitioned by database schema. In some other embodiments, each tenant 110, 120, 130 shares a common database schema within DBMS 140. In embodiments with common database schema across tenants, a tenant-specific term within a query restriction is provided to restrict data access to a particular tenant. For example, when structured query language (SQL) is employed as a query language, a “WHERE” clause restricting access to a particular tenant is employed. In these embodiments, application server 102 receives queries (with associated query statements) from querying users 112 and provides the query statement to data manager 104, which provides information regarding the query statement to security controller 106, which then appends additional query restrictions as further described below.

Turning now to FIG. 1B, which depicts a process diagram 150 illustrating a process for applying rules and roles to generate optimized queries for implementing restricted access to data in connection with the current subject matter. In various embodiments, data manager 104 receives queries, in the form of query statements, from query users 112 and coordinates processing of the query statements. In some embodiments to facilitate secure processing of the queries, data manager 104 coordinates processing with security controller 106. In some embodiments, security controller 106 establishes query restrictions at an application level so that data manager 104 can execute a query statement against DBMS 140 in such a way as to perform a secure query for querying user 112 at an application level.

At step 156, the process identifies a user, an action, and data type parameters. In some embodiments, a user may be identified by a user identifier, such as a userid or a username. In these embodiments the user may be authenticated using single-sign-on mechanisms or in connection with an authentication token such as an OAUTH2 token. In some embodiments, a technical user may be employed that is identified by a technical user identifier. Such technical users may be used for integration with other applications or for system-to-system connections which need to query data consistent with the present teachings. A user identifier is provided so that security controller 106 can ascertain or determine authorization roles and rules for the provided user. In some embodiments, the action may be a query action depending on a corresponding type of query statement. For example, if the query statement is an OData query, the action may be any type of an OData query action. On the other hand, if the corresponding query statement is a SQL statement the corresponding action may be any SQL action type, such as SELECT, INSERT, UPDATE, UPSERT, or DELETE. In some embodiments, the data type corresponds to a data type in the query statement. In these embodiments, a data type corresponds to a table or view to be queried or otherwise acted upon within a relational database management system. If the query statement is an OData query, the data type corresponds to a particular OData entity.

At step 158, the process generates a non-secure query statement. In some embodiments, this step involves formulating a query statement corresponding to the action sought to be performed. In the case of a read-only query such as a SQL SELECT statement, the query will set forth the table, which is intended to be queried, which may include a database schema. Alternatively, the database schema may be implied or default to the user's default schema. In addition to the table that is intended to be queried, a list of rows or fields to be queried may be provided in addition to JOIN statements and/or WHERE statements intended to limit the data that is intended to be accessed by the statement. It is understood that any other SQL syntax may be included in the query statement such as a statement limiting a number of rows to be returned. If the query statement is in the SQL format, any other SQL action may also be presented in connection with the non-secure query statement presented in connection with this step. If the non-secure query statement is presented in a different format such as OData, any non-secure OData query with corresponding action and parameters may be presented as the non-secure query statement in this step.

From here, processing migrates to security controller 106 at which point processing resumes at step 160 where a configuration is determined based on the parameters of [user, action, and data type] as set forth above in connection with step 156. Determination of configuration based on these parameters may be carried out in various ways. In some embodiments, an application itself will maintain authorization information regarding particular users in terms of what data the individual users should have access to. In these embodiments, a query to the application metadata may be carried out to access the authorization information in order to determine a configuration at this step. In some other embodiments, a separate application may serve as an authority for the corresponding authorization information. In yet other embodiments, a dedicated authorization server stores authorization information for particular users. In some such embodiments, an authorized connection to such a separate application or authorization server may first be established and then the authorization information obtained.

Next, at step 162 the associated configurations are transformed into an abstract condition tree. In some embodiments, application logic associated with software execution in connection with application server 102 is programmatically executed to transform the generated configurations into an abstract condition tree. Such abstract condition trees are used to simplify an associated query restrictor to simplify the ultimate query that is sent down to a database such as DBMS 140 to simplify the necessary computation of query results.

Next, at step 164, the abstract condition tree is optimized. In various embodiments, the abstract condition tree is optimized by reference to simplification operations that are utilized to simplify and optimize the associated abstract condition tree. At step 166, the abstract condition tree is transformed to a query restrictor as further described below. Next, at step 168, the query restrictor is returned to the call source by way of data manager 104. In some embodiments, this return is performed within the same application and may simply be passed by value or reference depending on the programming language being utilized. In some other embodiments, such as where the security controller 106 is hosted outside the application in which data manager 104 is hosted, the query restrictor may be returned in a response package associated with a response to an API request, such as where security controller is implemented as a RESTful service or a microservice.

At step 170, the query statement is secured by appending the query restrictor to the non-secure query statement. In some embodiments, this is carried out by combining the non-secure query restrictor terms with the secure query restrictor terms derived from step 168 above. For example, in the case of a SQL query statement, the non-secure WHERE clause terms are combined with WHERE clause terms associated with the query restrictor that is derived from the optimized abstract condition tree which was produced in connection with the transformed authorization configuration as set forth above in connection with steps 162 and 164 above.

Finally, at step 172 the secured query statement is executed against DBMS 140. In some embodiments, data manager 104 executes the query directly against DBMS 140, for example, using a database connection driver such as an ODBC driver or other mechanism for connecting to DBMS 140. In some other embodiments, a caching server is employed. In some other embodiments, where DBMS 140 is a distributed database system, the secured query statement is broken into distributed constituent pieces and executed in a distributed manner. In some other embodiments, the query statement is partially executed in connection with application server 102, where for example a query language processor is provided directly in application server 102, which may provide a cache and only make a query to DBMS 140 in the case that there is a cache miss, or the cached data is expired. In the case of a multi-tenant system in which tenants share a database schema, a tenant-specific query restrictor term is additionally appended to the query restrictor to limit results to data associated with the respective tenant. In some embodiments, a database cache associated with application server 102 caches and refreshes an associated cache exclusively with data associated with a tenant for which application server 102 is providing application services.

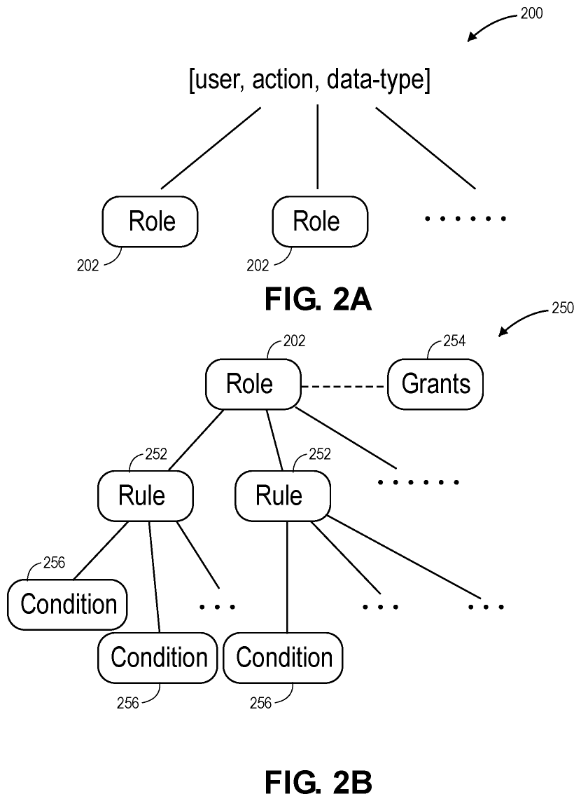

Turning now to FIG. 2A, which depicts a hierarchical diagram 200 illustrating relationships between a user, an action, a data type, and roles 202. In embodiments, the authorization configuration may be transformed into an abstract condition tree. The configuration may also be represented as a tree-structure, which in some embodiments may be directly mapped to an abstract condition tree. In connection with the above exemplary process illustrated in FIG. 1B, given necessary authorizations or permissions, a user can perform an action on a data set according to the given permissions. In order to perform a particular action, the target data set should be queried from a desired database and filtered by the permission restrictions (according to the query restrictor above). As noted above, associated actions may be view, edit, create, delete, import, an export, and any other action available in a given query statement format. The data set belongs to a data type, which usually maps to a database table in a relational database management system. The query can be an OData API query or a SQL query or any other database query statement format that can be used to query or perform an action on a database.

Turning now to FIG. 2B, which depicts a hierarchical diagram 250 illustrating relationships between roles 202, rules 252, grants 254, and conditions 256. In some embodiments, each tenant can configure roles 202 specific to the particular tenant, with a grant 254 being granted to a user. Each role 202 permits data types along with associated permitted actions for each data type. In various embodiments, roles 202 are made up of rules 252. Rules 252 are granted to user groups and may be made up of conditions 256. In various embodiments, conditions 256 may be of at least two different types, namely target population and target criteria: a target population condition specifies a group of users who own particular data records in a particular data set; and target criteria may specify logical predicates on data attributes that filter the data set. In some embodiments, the concept of being a data owner means being the particular entity to which the data pertains, i.e., in the case of personally identifiable information, a data owner is the individual whose particular personally identifiable information is applicable.

For example, a human resources (HR) role may permit users having a certain role 202 to perform actions on certain data types (e.g., employee table, position table, salary table). A detailed role configuration may be as follows. The HR role has the following permitted data types and actions. First, the HR role has “view” access to the employee table, “view” and “edit” access to the position table, and “view,” “edit,” and “create” access to the salary table. With respect to rules, rule1 may define that a granted population is defined as an HRGroup being made up of all HR users and a target population (meaning data owners) of group1, which may correspond to all senior software developers. In this example, target criteria are as follows: for the employee table, “all” access is permitted; for the position table the region=region1, which may be, for example, China. As to the salary table, rule1 defines access for region=region1 and employment type=“full time.” Similarly, for rule2, the granted population corresponds to a HRManagerGroup. Within rule2, a target population corresponds to group2, which may correspond to project managers. The corresponding target population is group2 and target criteria is as follows. For the employee table the rule corresponds to all employees. For the position table, the rule grants access to all positions, and for the salary table the type is full-time employees.

Accordingly, for the HR role, two rules are configured. Taking the Salary data type as an example, rule1 restricts that each data record should belong to a person in group1, the data record's region attribute should be equal to region1, and the data record's type attribute should be equal to full time. Rule2 restricts that a data record should belong to a person in group2, and the data record's type attribute should be equal to full time. Note that, “target_population: group1” will result in a SQL WHERE clause query fragment like “p IN group1” and “target_criteria: region=region1, type=full-time” will result in a query fragment like “region=region1 AND type=full-time.” In this example, p is a property of the record, a “person” in group1.

In various embodiments, target criteria may be assigned special values which are resolved to constant conditions. A value of “all,” meaning full access to all data, may be resolved to a constant condition “true,” and a value of “null,” meaning no access to any data is resolved to a constant condition of “false.” In these embodiments, when a user 112 attempts to perform an action on a data set, security controller 106 determines the configuration of roles 202 and rules 252 granted to the user and corresponding to the data type and the action, transforms the configuration to an abstract condition tree representing the query restrictor to secure the data query for the action, and the transformation takes the form of the following steps: (i) combine the conditions of each rule by conjunction like “rule=(condition1 AND condition2);” combine the rules of each role by disjunction “role=(rule1 OR rule2);” and combine the roles of the user by disjunction “user permission=(role1 OR role2).” Next, security controller 106 optimizes the abstract condition tree. Then security controller 106 transform the abstract condition tree to a query restrictor. Finally, security controller 106 returns the query restrictor to the call source.

For example, a user may attempt to view salaries for employees in a particular tenant (company.) By accessing authorization data as described above, it is determined by security controller 106 that the user has been granted rule1 of the HR role and therefore is authorized to view a subset of all tenant records in the salary table relating to salary data matching conditions (region=region1 and type=full-time). If the user also has an executive role that can view a larger data set than the HR role, the user will be able to view a larger data set. If rather than the executive role, the user has an employee role that is authorized only to view a smaller data set than that of the HR role, what the user can view depends on the HR role which has more permission.

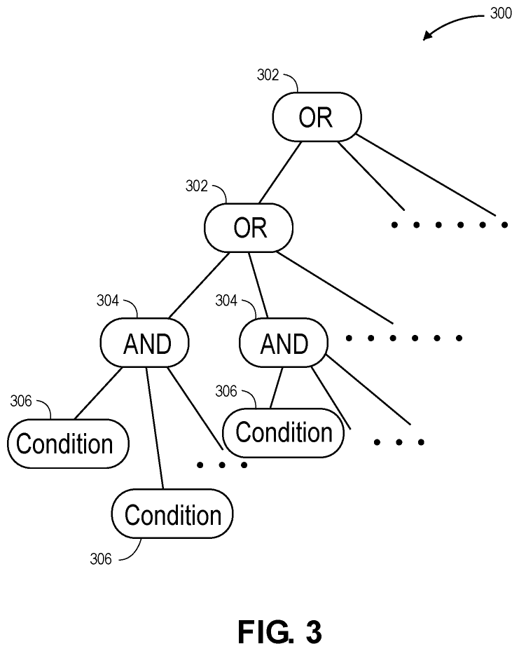

Turning now to FIG. 3, which depicts a tree 300 illustrating an unoptimized abstract condition tree. Tree 300 is made up of OR operator notes 302, AND operator notes 304 and conditions 306. In some embodiments, the unoptimized abstract condition tree is optimized as follows. In these embodiments, processing begins with the root node, proceeding with a top-down traversal, a leaf node is reached, then a bottom-up traversal may begin. In these embodiments, security controller 106 performs pattern matching and transformation by way of a bottom-up tree traversal. When a sub-tree matches a pattern within tree 300, a transformation may be applied to simplify the sub-tree. If all sub-trees of a particular node are optimized, and the particular node belongs to a parent tree, the parent itself is optimized. In some embodiments, during the optimization process, security controller 106 applies a constant reduction process to the following patterns. In these embodiments, a constant reduction process is applied to the bottom-up tree traversal such that during bottom-up traversal, all patterns are tested, and if there is a pattern match in the constant reduction pattern, the processing applies the corresponding pattern to the sub-tree. Where c stands for any condition 306, the expression: “c AND true” reduces to: c. The expression “c AND false” reduces to false. The expression “c OR true” reduces to true. Finally, the expression “c OR false” reduces to c. In some embodiments, these reductions may be applied to an unoptimized abstract condition tree to transform the unoptimized abstract condition to an optimized abstract condition tree. During optimization, security controller 106 applies the following patterns. Where c, c1, and c2 stand for any condition 306, the expression “(c AND r=R1) OR (c AND r=R2)” reduces to “c AND (r=R1 OR r=R2).” If G1 is subset of G2, the expression “(p IN G1) OR (p IN G2)” reduces to “p IN G2.” If G1 is not subset of G2 and G2 is not subset of G1, (p IN G1) OR (p IN G2)=>p IN (G1+G2). (c1 AND c2) OR c1=>c1. If G1 is subset of G2, ((p IN G1) AND c) OR (p IN G2)=>p IN G2. Next, the process transforms the abstract condition tree to a query restrictor. In some embodiments, each tree has an equivalent string representation, e.g. ((p IN G1) AND r=R1) OR ((p IN G1) AND r=R2). The query restrictor is an object taking the form of a parameterized form of the string representation of a query statement. In some embodiments, parameter values are extracted as bindings. An exemplary binding may be represented as follows.

```
{
  string: ((p IN ?) AND r=?) OR ((p IN ?) AND r=?)
  bindings: G1, R1, G1, R2
}
```

The query statement may be also represented in parameterized form so that the query restrictor may be appended. Then the query statement can be executed as a prepared statement cacheable by the database. For example, before appending a query restrictor, an example non-secure query statement may take the form of:

```
{
  string: SELECT id, detail FROM positions WHERE date >= ?
  bindings: D1
}
```

For example, after appending a query restrictor, a secure query statement may look like the following.

```
  {
    string: SELECT id, detail FROM positions WHERE date >= ? AND
(((p IN ?) AND r=?) OR ((p IN ?) AND r=?))
    bindings: D1, G1, R1, G1, R2
  }
```

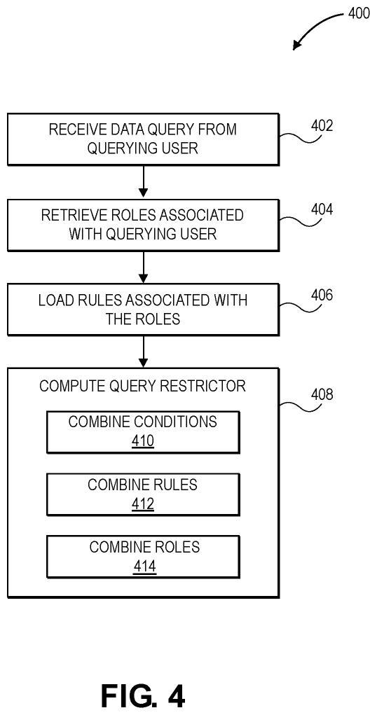

Turning now to FIG. 4, which depicts a process flow diagram 400 illustrating an exemplary process for applying rules 252 and roles 202 to generate optimized queries for implementing restricted access to data consistent with various embodiments. Rules 252 and roles 202 are applied to generate optimized queries for implementing restricted access to data.

At step 402, a data query statement is received from a querying user including a data type and a query action. In some embodiments, roles 202 associated with a querying user, are retrieved by security controller 106. In some such embodiments, the roles 202 may correspond to the querying user, the data type, and the query action. At step 404, roles 202 associated with a querying user are retrieved. In some embodiments, the data query is received in an open data protocol query data format. In some other embodiments, the data query is received in a structured query language format. In some other embodiments, the query action is one of: selecting data, updating data, inserting data, and deleting data. In some other embodiments, the query restrictor comprises an additional set of query terms associated with a where clause in the structured query language format.

At step 406, a plurality of rules 252 associated with the roles 202 are loaded by security controller 106. At step 408, based on the rules 252 and by way of security controller 106, a query restrictor is computed to secure the data query for the action. In some embodiments, at step 410, the computing step is performed by combining by conjunction one or more conditions associated with the rules. At step 412, the rules associated with the role 202 are combined by disjunction. At step 414, the roles to form restriction terms associated are combined by disjunction with the query restrictor. Finally, the data query is executed at a database server such as DBMS 140.

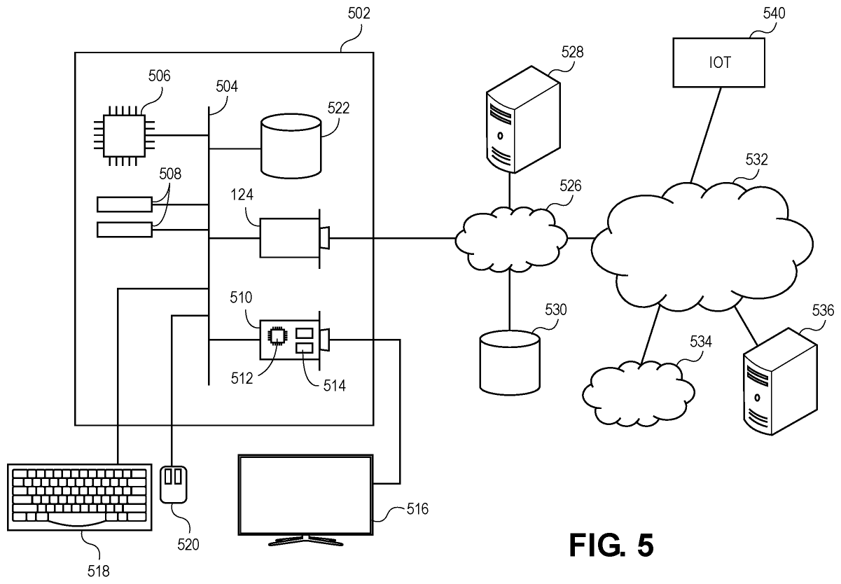

Turning now to FIG. 5, in which an exemplary hardware platform for certain embodiments is depicted. Computer 502 can be a desktop computer, a laptop computer, a server computer, a mobile device such as a smartphone or tablet, or any other form factor of general—or special-purpose computing device containing at least one processor. Depicted with computer 502 are several components, for illustrative purposes. In some embodiments, certain components may be arranged differently or absent. Additional components may also be present. Included in computer 502 is system bus 504, via which other components of computer 502 can communicate with each other. In certain embodiments, there may be multiple busses or components may communicate with each other directly. Connected to system bus 504 is central processing unit (CPU) 506. Also attached to system bus 504 are one or more random-access memory (RAM) modules 508. Also attached to system bus 504 is graphics card 510. In some embodiments, graphics card 510 may not be a physically separate card, but rather may be integrated into the motherboard or the CPU 506. In some embodiments, graphics card 510 has a separate graphics-processing unit (GPU) 512, which can be used for graphics processing or for general purpose computing (GPGPU). Also, on graphics card 510 is GPU memory 514. Connected (directly or indirectly) to graphics card 510 is display 516 for user interaction. In some embodiments no display is present, while in others it is integrated into computer 502. Similarly, peripherals such as keyboard 518 and mouse 520 are connected to system bus 504. Like display 516, these peripherals may be integrated into computer 502 or absent. Also connected to system bus 504 is local storage 522, which may be any form of computer-readable media, such as non-transitory computer readable media, and may be internally installed in computer 502 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 524 is also attached to system bus 504 and allows computer 502 to communicate over a network such as network 126. NIC 524 can be any form of network interface known in the art, such as Ethernet, ATM, fiber, Bluetooth, or Wi-Fi (i.e., the Institute of Electrical and Electronics Engineers (IEEE) 802.11 family of standards). NIC 524 connects computer 502 to local network 526, which may also include one or more other computers, such as computer 528, and network storage, such as data store 530. Generally, a data store such as data store 530 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 528, accessible on a local network such as local network 526, or remotely accessible over public Internet 532. Local network 526 is in turn connected to public Internet 532, which connects many networks such as local network 526, remote network 534 or directly attached computers such as computer 536. In some embodiments, computer 502 can itself be directly connected to public Internet 532.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. One or more non-transitory computer-readable media storing computer-executable instructions that, when executed by a processor, perform a method for applying rules and roles to generate optimized queries for implementing restricted access to data, the method comprising:
receiving, from a querying user, a data query including a data type and a query action;
retrieving, by a security controller, roles associated with the querying user, the roles corresponding to the data type and the query action;
loading, by the security controller, a plurality of rules associated with the roles;
based on the rules and by way of the security controller, computing a query restrictor to secure the data query for the action, the computing comprising:
combining by conjunction one or more conditions associated with the rules;
combining by disjunction the rules associated with the role; and
combining by disjunction the roles to form restriction terms associated with the query restrictor; and
executing the data query at a database server.

2. The non-transitory computer-readable media of claim 1, wherein the data query is received in an open data protocol query data format.

3. The non-transitory computer-readable media of claim 1, wherein the data query is received in a structured query language format.

4. The non-transitory computer-readable media of claim 3, wherein the query action is one of: selecting data, updating data, inserting data, and deleting data.

5. The non-transitory computer-readable media of claim 3, wherein the query restrictor comprises an additional set of query terms associated with a where clause in the structured query language format.

6. The non-transitory computer-readable media of claim 1, wherein computing a query restrictor further comprises:
determining a restriction configuration for:
the querying user;
the query action; and
the data type;
transforming the restriction configuration into an abstract condition tree; and
optimizing the abstract condition tree by simplifying the abstract condition tree according to the restriction configuration.

7. The non-transitory computer-readable media of claim 1, the method further comprising:
returning, to the querying user, filtered results corresponding to the data query.

8. A method for applying rules and roles to generate optimized queries for optimized queries implementing restricted access to data, the method comprising:
receiving
receiving, from a querying user, a data query including a data type and a query action;
retrieving, by a security controller, roles associated with the querying user, the roles corresponding to the data type and the query action;
loading, by the security controller, a plurality of rules associated with the roles;
based on the rules and by way of the security controller, computing a query restrictor to secure the data query for the action, the computing comprising:
combining by conjunction one or more conditions associated with the rules;
combining by disjunction the rules associated with the role; and
combining by disjunction the roles to form restriction terms associated with the query restrictor; and
executing the data query at a database server.

9. The method of claim 8, wherein the data query is received in an open data protocol query data format.

10. The method of claim 8, wherein the data query is received in a structured query language format.

11. The method of claim 10, wherein the query action is one of: selecting data, updating data, inserting data, and deleting data.

12. The method of claim 8, wherein the query restrictor comprises an additional set of query terms associated with a where clause in a structured query language format.

13. The method of claim 12, wherein computing a query restrictor further comprises:
determining a restriction configuration for:
the querying user;
the query action; and
the data type;
transforming the restriction configuration into an abstract condition tree; and
optimizing the abstract condition tree by simplifying the abstract condition tree according to the restriction configuration.

14. The method of claim 8, the method further comprising:
returning, to the querying user, filtered results corresponding to the data query.

15. A system comprising at least one processor and at least one non-transitory memory storing computer executable instructions that when executed by the processor cause the system to carry out actions comprising:
receiving, from a querying user, a data query including a data type and a query action;
retrieving, by a security controller, roles associated with the querying user, the roles corresponding to the data type and the query action;
loading, by the security controller, a plurality of rules associated with the roles;
based on the rules and by way of the security controller, computing a query restrictor to secure the data query for the action, the computing comprising:
combining by conjunction one or more conditions associated with the rules;
combining by disjunction the rules associated with the role; and
combining by disjunction the roles to form restriction terms associated with the query restrictor; and
executing the data query at a database server.

16. The system of claim 15, wherein the data query is received in an open data protocol query data format.

17. The system of claim 15, wherein the data query is received in a structured query language format.

18. The system of claim 17, wherein the query action is one of: selecting data, updating data, inserting data, conditionally updating or inserting, and deleting data.

19. The system of claim 17, wherein the query restrictor comprises an additional set of query terms associated with a where clause in the structured query language format.

20. The system of claim 19, wherein computing a query restrictor further comprises:
determining a restriction configuration for:
the querying user;
the query action; and
the data type;
transforming the restriction configuration into an abstract condition tree; and
optimizing the abstract condition tree by simplifying the abstract condition tree according to the restriction configuration.
